(19) United States
(12) Patent Application Publication
(10) Pub. No.: US 2024/0161549 A1
(43) Pub. Date: May 16, 2024

(54) TAGLESS MOBILE TICKET SERVICE METHOD

(71) Applicant: HYBEE, INC., Seongnam-si, Gyeonggi-do (KR)

(72) Inventors: Yong Hwan LEE, Seoul (KR); Jin Seok HAN, Seoul (KR); Jae Seok BANG, Seoul (KR); Hyun Joon LEE, Seoul (KR)

(21) Appl. No.: 18/283,559

(22) PCT Filed: Mar. 4, 2022
(86) PCT No.: PCT/KR2022/003102

§ 371 Date: Sep. 22, 2023

(30) Foreign Application Priority Data
Mar. 24, 2021 (KR) 10-2021-0037790

(51) Int. Cl. G07B 15/00; G06Q 20/32

(52) U.S. Cl. CPC G07B 15/00; G06Q 20/3223

(57) ABSTRACT

Provided is a tagless mobile ticket service method, which enables a user possessing a wireless terminal, in which a payment application capable of paving bills is installed, to pay for usage fees without being tagged at a ticket gate machine, The tagless mobile ticket service method includes: a user entry detecting step in which a ticket gate machine senses that a user possessing a user terminal accesses a ticket gate; a user information processing step in which bill payment information is acquired from the user terminal; a validity confirmation step in which the validity of the bill payment information is determined; and a user fee processing step in which a door is opened and a bill is paid using the bill payment information, if it is determined that the bill payment information is valid.

### TECHNICAL FIELD

The present invention relates to a tagless mobile ticket service method, and more specifically, to a tagless mobile ticket service method, which allows a user possessing a user terminal installed with a payment application (app) capable of processing fee payment to pay use fees without tagging the terminal at a turnstile device.

### BACKGROUND ART

Recently, ‘mobile ticket’ services are widely used in subways, performance halls, museums, theaters, and the like, instead of physical tickets of paper, magnetic cards, and the like, and the ‘mobile ticket’ service allows users possessing a wireless terminal device installed with an app capable of processing fee payment, such as a smartphone or the like, to pay use fees by tagging the wireless terminal device to a device for paying fees at a ticket gate, a gate, or the like.

Although these mobile ticket services may reduce the inconvenience and cost of using physical tickets, there is a limitation in that a user should perform a ‘tagging’ operation of approaching his or her wireless terminal device close to a device for paying fees. Therefore, it needs to implement more advanced tagless mobile ticket services.

In order to implement such tagless mobile ticket services, the following issues should be considered.

First, users are allowed to pay use fees without tagging their wireless terminal devices to a turnstile device. To this end, a short-distance communication method having a wider communication range (several meters), rather than an ultra-short distance (several centimeters) communication method such as near field communication (NFC) used in conventional tagging methods, will be suitable.

Second, users are allowed to pay use fees without handling their wireless terminal devices. When an operation of activating a payment app in their terminal devices should be preceded by the users before the users pass through a ticket gate or a gate, it is difficult to call it a true tagless mobile ticket service.

As a prior art document, there is Korean Patent Publication No. 10-2018-0134797.

### DISCLOSURE OF INVENTION

### Technical Problem

Therefore, the present invention has been made in view of the above problems, and it is an object of the present invention to provide a tagless mobile ticket service method, which allows a user possessing a user terminal instilled with a payment application (app) capable of processing fee payment to pay use fees without tagging the terminal at a turnstile device.

### Technical Solution

To accomplish the above object, according to one aspect of the present invention, there is provided a tagless mobile ticket service method performed by a turnstile device, the method comprising: a user entry detecting step of detecting entry of a user into a ticket gate; a user information processing step of acquiring fee payment information from a user terminal possessed by the user; a validity confirmation step of determining validity of the fee payment information; and a user fee processing step of opening a door and performing fee payment using the fee payment information when it is determined that the fee payment information is valid.

In addition, the user entry detecting step may include the steps of: detecting that the user has entered the ticket gate using a first object detecting unit installed at an entrance of the ticket gate and a second object detecting unit installed at a predetermined distance from the first object detecting unit; and detecting that the user has passed through the ticket gate using a third object detecting unit installed at an exit of the ticket gate.

In addition, the user information processing step may include the steps of: activating communication of a wireless communication unit when entry of the user into the ticket gate is detected by the first object detecting unit; and performing communication between the wireless communication unit and the user terminal when the second object detecting unit detects entry of the user into the ticket gate while the first object detecting unit detects entry of the user into the ticket gate, wherein the fee payment information may be acquired from the user terminal when the user is no longer detected by the second object detecting unit.

In addition, at the step of performing communication between the wireless communication unit and the user terminal, when a plurality of user terminals is sensed by the wireless communication unit, a user terminal having a maximum signal strength that is higher than a threshold value may be determined as the user terminal entering the ticket gate.

In addition, the tagless mobile ticket service method may further comprise the step of performing an alarm action when it is determined that the fee payment information is invalid.

In addition, the user information processing step may further include the steps of: confirming that the user has quit entering the ticket gate when the user is no longer detected by the second object detecting unit and the first object detecting unit detects the user and then the user is no longer detected by the first object detecting unit; and terminating acquisition of the fee payment information when it is confirmed that the user has quit entering the ticket gate.

In addition, the user fee processing step may include the steps of: informing the user terminal of fee payment and opening the door when it is determined that the fee payment information is valid; confirming whether the user has passed through the ticket gate using the third object detecting unit; and closing the door and performing fee payment using the fee payment information when it is confirmed that the user has passed through the ticket gate.

In addition, the tagless mobile ticket service method may further comprise the step of, after the step of confirming whether the user has passed through the ticket gate using the third object detecting unit, performing an alarm action when it confirmed that the user has not passed through the ticket gate.

In addition, in the turnstile device, the wireless communication unit may transmit and receive signals to and from the user terminal using a multi-antenna technique, and the signals may have directivity of being radiated and received to and from an inner area of the ticket gate.

On the other hand, according to another aspect of the present invention, there is provided a tagless mobile ticket service method performed by a user terminal, the method comprising the steps of: activating a payment app when a signal is received from a wireless communication device; setting transmission/reception duty-cycle of a wireless communication unit to a higher level when the payment app is activated; attempting fee payment during a pre-defined time period; and resetting the transmission/reception duty cycle of the wireless communication unit to a previous level when it is confirmed that the fee payment is completed.

### Advantageous Effects

According to the present invention, there is an effect of paying use fees using a user terminal, a wireless communication device, and an object detecting unit of a turnstile device, without a user's tagging operation.

According to the present invention, as activation and deactivation of a user terminal app is controlled using a wireless communication device near a ticket gate, there is an effect of removing a process of manually controlling the app by the user in consideration of power consumption of the user terminal.

### BRIEF DESCRIPTION OF THE DRAWINGS

FIG. 1 is a view schematically showing a tagless mobile ticket service device according to an embodiment of the present invention.

FIG. 2 is a block diagram showing the configuration of a tagless mobile ticket service device according to an embodiment of the present invention.

FIG. 3 is a flowchart illustrating a tagless mobile ticket service method according to an embodiment of the present invention.

FIG. 4 is a flowchart illustrating the operation process of the user terminal in FIG. 1.

### BEST MODE FOR CARRYING OUT THE INVENTION

Hereinafter, preferred embodiments of the present invention will be described in detail with reference to the accompanying drawings in order to clarify the technical spirit of the present invention. When it is determined in describing the present invention that a detailed description of a related known function or component may unnecessarily obscure the subject matters of the present invention, the detailed description will be omitted. Components having substantially the same functional configuration in the drawings are given the same reference numerals and symbols as much as possible although they are shown in different drawings. For convenience of explanation, the device and method are described together when necessary.

Hereinafter, the term “unit” is defined herein as having its broadest definition to ordinary skill in the art to refer to software including instructions executable in a non-transitory computer-readable medium that would perform the associated function when executed, a circuit or a processor designed to perform the associated function, hardware designed to perform the associated function, or a combination of them.

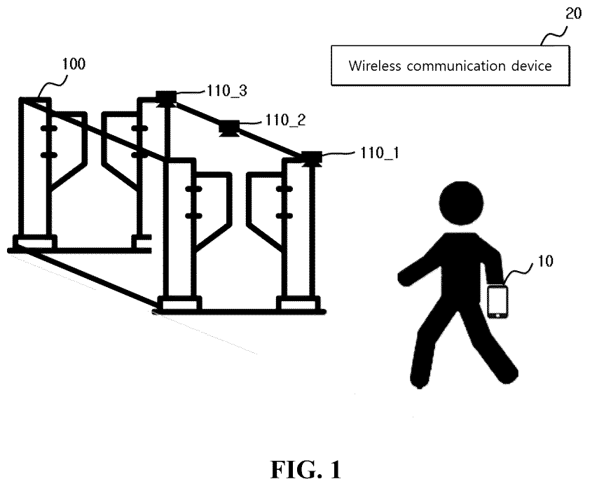

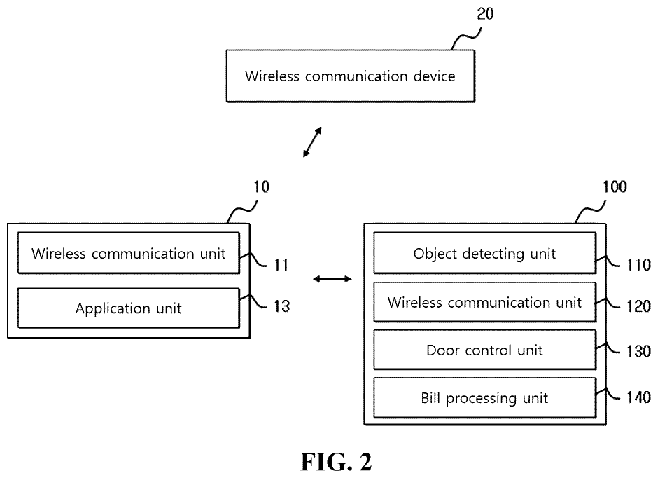

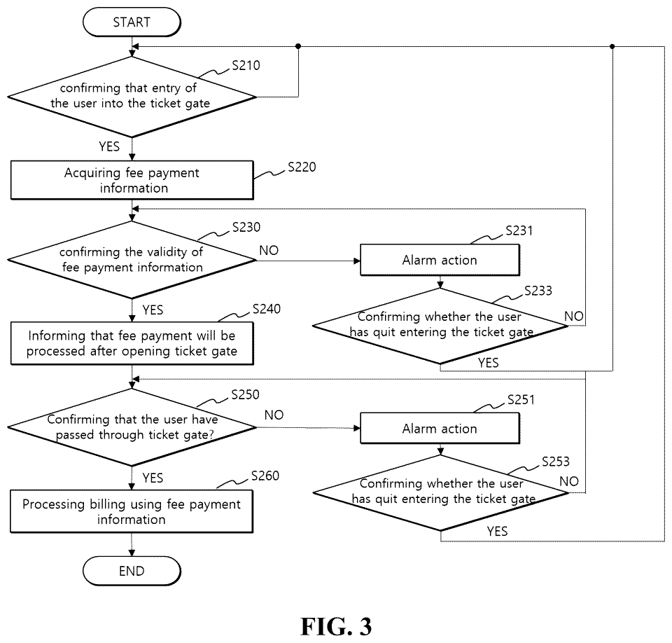

FIG. 1 is a view schematically showing a tagless mobile ticket service device according to an embodiment of the present invention, and FIG. 2 is a block diagram showing the configuration of a tagless mobile ticket service device according to an embodiment of the present invention. In addition, FIG. 3 is a flowchart illustrating a tagless mobile ticket service method according to an embodiment of the present invention.

Referring to FIGS. 1, 2, and 3, a tagless mobile ticket service device may include a user terminal 10 installed with a payment app capable of processing fee payment of a user, a wireless communication device 20 capable of communication, and a turnstile device 100.

The user terminal 10 may include a wireless communication unit 11 and an application unit 13.

The wireless communication unit 11 may receive signals from the wireless communication device 20. In addition, the wireless communication unit 11 may transmit and receive fee payment information and signals to and from a wireless communication unit 120 of the turnstile device 100.

The application unit 13 may activate or deactivate the payment app through the received signal.

In addition, the application unit 13 may perform fee payment.

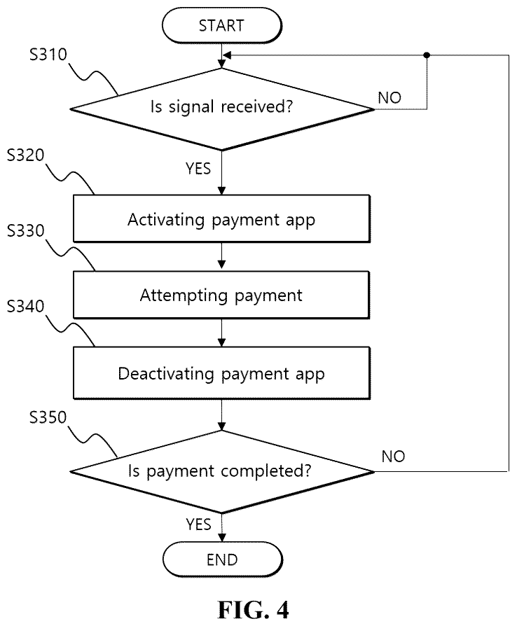

The detailed operation process of the user terminal 10 will be described below with reference to FIG. 4.

The wireless communication device 20 may be implemented to include a wireless communication unit. The wireless communication device 20 is installed near the turnstile device 100, and one or more wireless communication devices 20 may be installed. The wireless communication device 20 may transmit signals to the user terminal.

The turnstile device 100 may include an object detecting unit 110, a wireless communication unit 120, a door control unit 130, and a bill processing unit 140. In addition, the wireless communication unit 120 is installed on both sides of the ticket gate to transmit and receive signals to and from the user terminal 10 using a multi-antenna technique, and the signals may have directivity of being radiated and received to and from the inner area of the ticket gate.

The object detecting unit 110 may be implemented to include a sensor capable of detecting objects. Therefore, the object detecting unit 110 may detect user's movement and confirm whether a user enters, quits entering (returns), or passes through the ticket gate. The object detecting unit 110 may include one or more object sensors. In an embodiment, the object detecting unit 110 may include a first object detecting unit 110_1 installed at the entrance of the ticket gate, a second object detecting unit 110_2 installed at a predetermined distance from the first object detecting unit 110_1, and a third object detecting unit 110_3 installed at the exit of the ticket gate.

The turnstile device 100 may confirm whether the user has entered the ticket gate using the object detecting unit 110 (S210). When it is confirmed that the user has entered the ticket gate (S210: Yes), the turnstile device 100 acquires fee payment information needed for payment of a use fee from the user terminal 10 possessed by the user detected to have entered the ticket gate (S220). On the contrary, when it is confirmed that the user has not entered the ticket gate (S210: No), the turnstile device 100 may return to an initial state.

A process of confirming whether a user has entered a ticket gate using the object detecting unit 110 by the turnstile device 100 will be described.

The turnstile device 100 may install the first object detecting unit 110_1 at the entrance of the ticket gate, and install the second object detecting unit 110_2 at a predetermined distance from the first object detecting unit 110_1. Here, the predetermined distance may mean a distance slightly less than the thickness of a person's waist from the first object detecting unit 110_1 or a distance set by a designer.

When entry of a user is detected by the first object detecting unit 110_1, communication of the wireless communication unit 120 of the turnstile device 100 may be activated. Thereafter, when the second object detecting unit 110_2 detects entry of the user into the ticket gate while the first object detecting unit 110_1 detects entry of the user into the ticket gate, the wireless communication unit 120 may perform communication with the user terminal 10. At this point, when a plurality of user terminals is sensed, the wireless communication unit 120 may determine a user terminal having a maximum signal strength that is higher than a threshold value as the user terminal 10 of the user entering the ticket gate.

Thereafter, when the user is no longer detected by the first object detecting unit 110_1 while entry of the user is being detected by the second object detecting unit 110_2, the turnstile device 100 may confirm that the user has entered the ticket gate. Thereafter, the wireless communication unit 120 may acquire user's fee payment information from the user terminal 10.

Meanwhile, the turnstile device 100 may determine that the user has quit entering the ticket gate at the moment when the user is no longer detected by the first object detecting unit 110_1 after the user is no longer detected by the second object detecting unit 110_2 while the user is being detected by the first object detecting unit 110_1.

The turnstile device 100 may determine validity of the acquired fee payment information (S230). When it is determined that the fee payment information is valid (S230: Yes), the turnstile device 100 may open the door of the ticket gate using the door control unit 130 so that the user may pass through the exit of the ticket gate, and inform that fee payment of the user terminal 10 will be proceeded (S240).

A process of confirming validity of the fee payment information by the turnstile device 100 will be described. When communication of the wireless communication unit 120 with the user terminal 10, of which entry into the ticket gate is confirmed, is not activated within a pre-defined time, the turnstile device 100 determines that the user terminal 10 is abnormal and the acquired fee payment information is invalid. In addition, when the fee payment information acquired from the user terminal 10, of which entry into the ticket gate is confirmed, is not normal, the turnstile device 100 determines that the acquired fee payment information is invalid. In an embodiment, the turnstile device 100 may determine that the acquired fee payment information is invalid when it is confirmed that the balance information acquired from the user terminal 10 is insufficient.

Meanwhile, when the turnstile device 100 determines that the acquired fee payment information is invalid (S230: No), it may perform an alarm action (S231). In an embodiment, an alarm may be visually informed through a warning light (not shown) installed around the turnstile device 100, or a warning sound may be generated through a speaker (not shown).

Thereafter, the turnstile device 100 may confirm whether the user has quit entering the ticket gate (S233). Then, the turnstile device 100 may return to an initial state when it is confirmed that the user has quit entering the ticket gate (S233: Yes). On the other hand, when it is not confirmed whether the user has quit entering the ticket gate (S233: No), the turnstile device 100 may returns to step S230 and determine again validity of the acquired fee payment information.

A process of determining whether the user has quit entering the ticket gate by the turnstile device 100 will be described.

The turnstile device 100 confirms that the user has quit entering the ticket gate when the user is no longer detected by the first object detecting unit 110_1 after the user is detected by the first object detecting unit 110_1 after the user is no longer detected by the second object unit 110_2.

In addition, the turnstile device 100 may confirm whether the user has completely passed through the ticket gate (S250). When it is confirmed that the user has completely passed through the ticket gate, the turnstile device 100 may proceed for billing using the fee payment information through the bill processing unit 140 (S260). That is, the turnstile device 100 performs fee payment using the fee payment information.

On the other hand, when the turnstile device 100 determines that the user has not completely passed through the ticket gate (S250: No), it performs an alarm action (S251). Then, the turnstile device 100 confirms whether the user has quit entering the ticket gate (S253). When it is confirmed that the user has quit passing through the ticket gate and also has quit entering the ticket gate (S253: Yes), the turnstile device 100 returns to the initial state. However, when it is not confirmed whether the user has quit entering the ticket gate (S253: No), the ticket gate device 100 returns to step 5250 and confirms again whether the user has completely passed through the ticket gate.

A process of confirming whether the user has completely passed through the ticket gate by the turnstile device 100 will be described.

The turnstile device 100 may install a third object detecting unit 110_3 at the exit of the ticket gate. When the user is no longer detected by the third object detecting unit 110_3 after entry of the user is detected by the third object detecting unit 110_3, the turnstile device 100 determines that the user has completely passed through the ticket gate. Therefore, the turnstile device 100 may confirm whether the user has completely passed through the ticket gate using the third object detecting unit 110_3.

The process of confirming whether the user has abandoned entering the ticket gate by the turnstile device 100 at step S253 is the same as step S233. That is, the turnstile device 100 confirms that the user has quit entering the ticket gate when the user is no longer detected by the first object detecting unit 110_1 after the user is detected by the first object detecting unit 110_1 after the user is no longer detected by the second object unit 110_2.

Accordingly, in the tagless mobile ticket service method, users possessing a user terminal installed with a payment application (app) capable of processing fee payment may pay use fees without tagging the terminal at a turnstile device.

FIG. 4 is a flowchart illustrating the operation process of the user terminal in FIG. 1.

Referring to FIGS. 1 to 4, the user terminal 10 may confirm whether the wireless communication unit 11 receives a signal from the wireless communication device 20 installed near the ticket gate (S310). That is, the wireless communication unit 11 may receive signals from the wireless communication device 20.

As an example of the process of confirming by the user terminal 10 whether the wireless communication unit 11 has received a signal from the wireless communication devices 20, whether the wireless communication unit 11 has received a signal may be confirmed as the user terminal 10 receives a Wi-Fi or Bluetooth signal transmitted from the wireless communication device 20.

Accordingly, when the wireless communication unit 11 receives a signal from the wireless communication device 20 (S310: Yes), the application unit 13 activates the payment app (S320).

As an example of the process of activating the payment app by the application unit 13 in the user terminal 10, the application unit 13 activates the payment app, and sets transmission/reception duty-cycle of the wireless communication unit 11 to a high level.

Thereafter, the application unit 13 attempts fee payment during a pre-defined time period (S330). As an example of the process of attempting fee payment by the application unit 13 of the user terminal 10, when the application unit 13 attempts fee payment during a maximum time (T), and the time (T) is elapsed or the payment is completed within the time (T), it moves to the next step.

Then, the application unit 13 deactivates the payment app (S340) and confirms whether the payment has been completed (S350). As an example of the process of deactivating the payment app by the application unit 13 in the user terminal 10, the application unit 13 deactivates the payment app, and resets the transmission/reception duty-cycle of the wireless communication unit 11 to a previous level.

That is, when the application unit 13 in the user terminal 10 confirms that the payment has been completed, the wireless communication unit 11 may reset the transmission/reception duty cycle to a previous level. In addition, when the user terminal 10 does not complete the payment within the pre-defeined time period, the wireless communication unit 11 may reset the transmission/reception duty cycle to a previous level.

When the user terminal 10 confirms that the payment is completed (S350: Yes), the fee payment process is terminated. On the other hand, when the payment is not completed (S350: No), the user terminal 10 returns to step 310.

Until now, the present invention has been described in detail focusing on the preferred embodiments shown in the drawings. These embodiments are merely illustrative, rather than limiting of the present invention, and should be considered in an illustrative viewpoint, rather than a limiting viewpoint. The true technical scope of protection of the present invention should be determined by the technical spirit of the appended claims rather than the foregoing descriptions. Although specific terms are used in this specification, they are only used for the purpose of explaining the concept of the present invention and are not used to restrict the meaning or limit the scope of the present invention described in claims. Each step of the present invention does not necessarily need to be performed in the described order and may be performed in parallel, selectively, or individually. Those skilled in the art will understand that various modifications and other equivalent embodiments are possible without departing from the essential technical spirit of the present invention claimed in the claims. It should be understood that the equivalents include all components invented to perform the same function regardless of the equivalents, i.e., structures, developed in the future, as well as currently known equivalents.

1. A tagless mobile ticket service method performed by a turnstile device, the method comprising:
a user entry detecting step of detecting entry of a user into a ticket gate;
a user information processing step of acquiring fee payment information from a user terminal possessed by the user;
a validity confirmation step of determining validity of the fee payment information; and
a user fee processing step of opening a door and performing fee payment using the fee payment information when it is determined that the fee payment information is valid.

2. The method according to claim 1, wherein the user entry detecting step includes the steps of:
detecting that the user has entered the ticket gate using a first object detecting unit installed at an entrance of the ticket gate and a second object detecting unit installed at a predetermined distance from the first object detecting unit; and
detecting that the user has passed through the ticket gate using a third object detecting unit installed at an exit of the ticket gate.

3. The method according to claim 2, wherein the user information processing step includes the steps of:
activating communication of a wireless communication unit when entry of the user into the ticket gate is detected by the first object detecting unit; and
performing communication between the wireless communication unit and the user terminal when the second object detecting unit detects entry of the user into the ticket gate while the first object detecting unit detects entry of the user into the ticket gate, wherein
the fee payment information is acquired from the user terminal when the user is no longer detected by the second object detecting unit.

4. The method according to claim 3, wherein at the step of performing communication between the wireless communication unit and the user terminal, when a plurality of user terminals is sensed by the wireless communication unit, a user terminal having a maximum signal strength that is higher than a threshold value is determined as the user terminal entering the ticket gate.

5. The method according to claim 1, further comprising the step of performing an alarm action when it is determined that the fee payment information is invalid.

6. The method according to claim 2, wherein the user information processing step further includes the steps of:
confirming that the user has quit entering the ticket gate
when the user is no longer detected by the first object detecting unit, after the user is detected by the first object detecting unit, after the user is no longer detected by the second object detecting unit; and
terminating acquisition of the fee payment information when it is confirmed that the user has quit entering the ticket gate.

7. The method according to claim 2, wherein the user fee processing step includes the steps of:
informing the user terminal of fee payment and opening the door when it is determined that the fee payment information is valid;
confirming whether the user has passed through the ticket gate using the third object detecting unit; and
closing the door and performing fee payment using the fee payment information when it is confirmed that the user has passed through the ticket gate.

8. The method according to claim 7, further comprising the step of, after the step of confirming whether the user has passed through the ticket gate using the third object detecting unit, performing an alarm action when it confirmed that the user has not passed through the ticket gate.

9. The method according to claim 1, wherein in the turnstile device, the wireless communication unit transmits and receives signals to and from the user terminal using a multi-antenna technique, and the signals have directivity of being radiated and received to and from an inner area of the ticket gate.

10. A tagless mobile ticket service method performed by a user terminal, the method comprising the steps of:
activating a payment app when a signal is received from a wireless communication device;
setting transmission/reception duty-cycle of a wireless communication unit to a higher level when the payment app is activated;
attempting fee payment during a pre-defined time period; and
resetting the transmission/reception duty cycle of the wireless communication unit to a previous level when it is confirmed that the fee payment is completed.
